(19) United States
(12) Patent Application Publication
(10) Pub. No.: US 2023/0141268 A1
(43) Pub. Date: May 11, 2023

(54) MILLABLE POLYURETHANE-BASED POWER TRANSMISSION BELTS, COMPONENTS THEREOF, AND METHODS FOR MANUFACTURING THE SAME

(71) Applicant: THE GATES CORPORATION, Denver, CO (US)

(72) Inventors: Thomas S. MOSS, Englewood, CO (US); Charles F. OCHOA, Columbia, MO (US); Bobbie E. SOUTH, Columbia, MO (US); Patrick Joseph MCNAMEE, Monument, CO (US); Amanda AYRISS, Englewood, CO (US); Maggie S. SACKSE, III, Englewood, CO (US); Carol WEBER, Englewood, CO (US)

(21) Appl. No.: 17/955,521

(22) Filed: Sep. 28, 2022

Related U.S. Application Data
(60) Provisional application No. 63/276,330, filed on Nov. 5, 2021.

(51) Int. Cl. C08L 75/06; C08L 75/08

(52) U.S. Cl. CPC C08L 75/06; C08L 75/08

(57) ABSTRACT

Compositions for material layers suitable for use in power transmission belts are described. The composition includes millable polyurethane, such as polyester-based millable polyurethane or polyether-based millable polyurethane, such that material layers formed from the composition are solid but pliable. The disclosed material layers can be used to form the main body portion of power transmission belts, such as synchronous belts, V-belts, and micro-V belts.

### CROSS-REFERENCE TO RELATED APPLICATION(S)

The present application claims the benefit of priority to U.S. Provisional Patent Application No. 63/276,330, entitled “MILLABLE POLYURETHANE-BASED POWER TRANSMISSION BELTS, COMPONENTS THEREOF, AND METHODS OF MANUFACTURING THE SAME”, filed on Nov. 5, 2021, the entirety of which is hereby incorporated by reference.

### BACKGROUND

Many different types of power transmission belts are in existence today, including, but not limited to, synchronous belts, V-belts, and micro-V belts. One feature that many types of power transmission belts have in common is the use of a polyurethane elastomer material for the main body portion of the belt, including the ribs or teeth that may be formed therein.

Traditionally, the polyurethane material used in the manufacture of power transmission belts is a castable (i.e., liquid) polyurethane composition. As such, the manufacture of power transmission belts typically requires injection molding processing steps and associated equipment. In these processing steps, the liquid polyurethane is injected into a mold or die having the desired shape and/or surface features (e.g., teeth or ribs) for the base portion of the belt, after which the material is cured to harden the material in the shape of the mold or die. The molded material may then be ejected from the mold or die and incorporated with other components of the belt, such as backing layers and surface layers.

The equipment required for injection molding steps in the production of various types of power transmission belts can be highly specialized and therefore very expensive. The expense of the specialized equipment needed to carry out the injection molding process steps generally limits the number of machines that a manufacturer is willing to invest in. This tends to limit overall production of power transmission belts as well as the number of locations where production of power transmission belts is carried out. That is to say, the manufacture of power transmission belts tends to become highly regional or localized due to the mass distribution of machinery across a wider territory being generally cost prohibitive. All of these factors contribute to the cost of manufacturing power transmission belts being generally higher than other manufacturing processes using less expensive and more widely distributed machinery.

Another problem associated with the use of castable polyurethane in the manufacture of power transmission belts is the difficult handling characteristics of the castable polyurethane material. Because castable polyurethane is generally in the form of a liquid, numerous complexities arise in the manufacturing process due to the difficulties in handling and generally controlling the liquid material.

Accordingly, a need exists for improved materials and manufacturing processes in the field of power transmission belts.

### SUMMARY

This Summary is provided to introduce a selection of concepts in a simplified form that are further described below in the Detailed Description. This Summary, and the foregoing Background, is not intended to identify key aspects or essential aspects of the claimed subject matter. Moreover, this Summary is not intended for use as an aid in determining the scope of the claimed subject matter.

In some embodiments, a power transmission belt comprises a main body portion into which a plurality of surface features, such as ribs or teeth, may be molded. The composition of the main body portion includes millable polyurethane, such as polyester-based millable polyurethane or polyether-based millable polyurethane. The power transmission belt can be, e.g., a synchronous belt, a V-belt or a micro-V belt.

In some embodiments, a method of manufacturing a power transmission belt includes the steps of slab building a plurality of layers on a first section of a mold, enclosing the plurality of layers with a second section of the mold disposed on the first section of the mold, and applying heat and pressure to the plurality of layers disposed in the mold to mold together the plurality of layers and form a plurality of surface features on a top or bottom surface of the plurality of layers. At least one layer in the plurality of layers is a layer of main body portion material, the main body portion material comprising millable polyurethane. The millable polyurethane can be polyester-based millable polyurethane or polyether-based millable polyurethane.

In some embodiments, a millable polyurethane composition suitable for use in preparing a sheet of power transmission main body portion material includes a polyether- or polyester-based millable polyurethane, optionally, at least one additional elastomer, a curing agent, and a reinforcing filler dispersed throughout the composition.

These and other aspects of the technology described herein will be apparent after consideration of the Detailed Description and Figures herein. It is to be understood, however, that the scope of the claimed subject matter shall be determined by the claims as issued and not by whether given subject matter addresses any or all issues noted in the Background or includes any features or aspects recited in the Summary.

### BRIEF DESCRIPTION OF THE DRAWINGS

Non-limiting and non-exhaustive embodiments of the disclosed technology, including the preferred embodiment, are described with reference to the following figures, wherein like reference numerals refer to like parts throughout the various views unless otherwise specified.

FIG. 1 is a cross-section perspective view of a synchronous belt including a main body portion having a composition in accordance with various embodiments described herein.

FIG. 2 is a flow chart illustrating a method for making a power transmission belt in accordance with various embodiments described herein.

### DETAILED DESCRIPTION

Embodiments are described more fully below with reference to the accompanying Figures, which form a part hereof and show, by way of illustration, specific exemplary embodiments. These embodiments are disclosed in sufficient detail to enable those skilled in the art to practice the invention. However, embodiments may be implemented in many different forms and should not be construed as being limited to the embodiments set forth herein. The following detailed description is, therefore, not to be taken in a limiting sense.

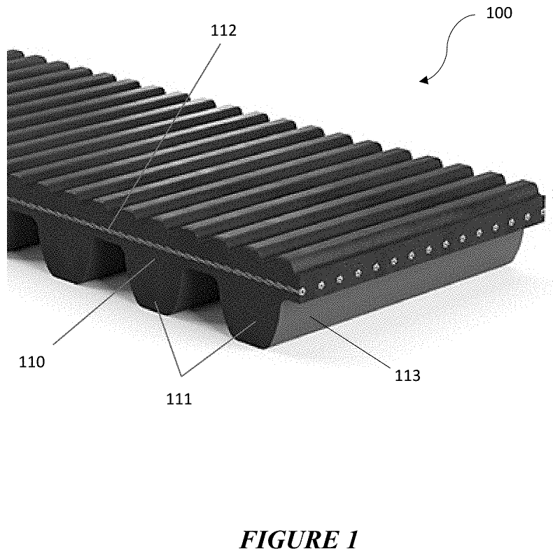

With reference to FIG. 1, an embodiment of a synchronous belt 100 is illustrated. The belt 100 generally includes a main body portion 110, all of which may be made from the same material. The main body portion 110 includes the surface features 111 formed in a surface of the main body portion 110, such as by molding a generally planar surface of the main body portion 100 during manufacturing of the belt 100 to thereby form the shaped surface features 111 in the main body portion 110. In FIG. 1, the surface features 111 are generally in the form of teeth oriented perpendicular to a direction of travel of the belt 100. However, it should be appreciated that the specific shape, size and orientation of the surface features 111 is not limited. For example, the surface features 111 can be formed in the main body portion 110 such that they are oriented parallel to the direction of travel of the belt 100, in which case the surface features 111 are generally considered ribs.

As also shown in FIG. 1, a series of tensile cords 112 are embedded within the main body portion 110. The tensile cords 112 are generally oriented parallel to the direction of travel of the belt 100. Parameters such as the wind angle, wind tension and the spacing between adjacent winds of cord 112 can be adjusted as desired for the finished product. The material of the cord 112 is generally not limited, and in some embodiments, may include metal, aramid, carbon fiber, nylon, polyester, glass, ceramic and various composite materials and may include hybrid mixtures of materials. The dimensions of the cord 112 itself (e.g., diameter) are not limited and may be selected based on the desired final application of the belt 100.

FIG. 1 further illustrates the belt 100 as including a surface layer 113 formed over the surface features 111 of the belt 100. The material and thickness of the surface layer 113, if used, is generally not limited, and may be selected based on, for example, the specific attributes to be imparted to the belt by virtue of using the surface layer 113. For example, a surface layer 113 can be provided to adjust the coefficient of friction of the belt 100, reduce the noise of the belt 100, etc.

Other layers not shown in FIG. 1 can also be optionally included in the belt 100 as desired or needed based on the specific application of the belt 100. For example, the belt 100 may include a backing layer formed on the opposite surface of the main body portion 110 from the surface in which the surface features 111 are formed.

Returning back to the main body portion 110 of belt 100 shown in FIG. 1, an embodiment of the technology described herein utilizes millable (or milled) polyurethane as a main component of the material used for the main body portion. Millable polyurethane generally refers to a polyurethane produced with a stoichiometric deficiency of diisocyanate and which exists in a solid but viscous or pliable form. That is to say, millable polyurethane, once milled and optionally combined with other additives, can be provided in the form of, e.g., solid but pliable sheets. As discussed in greater detail below, these solid sheets of milled polyurethane (which may have additional components incorporated therein) can undergo further processing, such as molding using pressure and heat, in order to manufacture various goods having desired shapes (including, e.g., surface features).

Any suitable millable polyurethane can be used as the millable polyurethane component of the main body portion material, including either polyether-based millable polyurethane or polyester-based millable polyurethane. The specific polyether used in polyether-based millable polyurethanes is generally not limited, and my include, for example, polytetramethylene ether glycol (PTMEG). The specific polyester used in polyester-based millable polyurethanes is generally not limited. Polyester- and polyether-based millable polyurethane may have different attributes making them more suitable for specific applications. For example, polyether-based millable polyurethanes have better hydrolysis and water resistance, while polyester-based millable polyurethanes have heat, oil and compression set resistance.

For the composition of the material used for the main body portion of the belt, the composition may include greater than 50 wt. % millable polyurethane based on the total elastomer content of the composition. In some embodiments, the millable polyurethane content of the composition is greater than 60 wt. %, greater than 70 wt. %, greater than 80 wt. % or greater than 90 wt. % of the total elastomer content in the material.

The millable polyurethane component of the composition used for the main body portion of the belt may be made up of a single millable polyurethane, or may be a combination of different millable polyurethanes. Any combination of millable polyurethanes can be used to provide the desired millable polyurethane content in the composition of the main body portion material. In some embodiments where multiple millable polyurethanes are used, the millable polyurethanes are either all polyester-based millable polyurethanes or all polyether-based millable polyurethanes. In other embodiments, a mix of both polyether and polyester millable polyurethanes can be used.

The composition of the material used for the main body portion of the belt may further include one or more additional elastomers (i.e., elastomers other than the millable polyurethane components described previously). When other elastomers are included in the composition, the other elastomers may comprise less than 50 wt. % less than 25 wt. %, or from about 5 wt. % to about 10 wt. % of the total elastomeric content of the composition. Exemplary, though non-limiting, additional elastomers that may be used with the millable polyurethane include silicone rubber, EPDM, EPR, EOM, EBM, EBT, ethylene elastomers (such as ethylene acrylic elastomer), polychloroprene, epichlorohydrin, hydrogenated nitrile butadiene rubber, natural rubber, ethylene-vinyl-acetate copolymer, ethylene methacrylate copolymers and terpolymers, styrene butadiene rubber, nitrile rubber, chlorinated polyethylene, chlorosulfonated polyethylene, alkylated chlorosulfonated polyethylene, transpolyoctenamer, polyacrylic rubbers, butadiene rubber, and mixtures thereof. The inclusion of additional elastomers may be to, for example, fine-tune certain mechanical properties of the main body portion material, such as high temperature performance and tack.

In some embodiments, the composition of the main body portion material further includes reinforcing material. For example, reinforcing particulate may be dispersed throughout the composition. In some embodiments, the composition of the main body portion material includes from about 25 to about 250 phr, such as from about 25 to about 100 phr, of a reinforcing particulate such as carbon black, calcium carbonate, talc, clay or hydrated silica, or mixtures of the foregoing

Reinforcing material may also be provided in the composition in the form of reinforcing fiber. For example, in some embodiments, the composition includes discontinuous fibers dispersed throughout the material. Reinforcing fiber can be in the form of conventional staple fiber or pulp fiber reinforcement materials. Examples of fiber having suitable tensile modulus and wear resistant qualities are aramid fibers, such as those sold under the trademark KEVLAR by E. I. du Pont de Nemours & Company; the trademark TECHNORA as sold by Teijin of Japan; and the trademark TWARON as sold by Enka of Holland. Non-aramid fiber, whether synthetic or natural, may also be used. Staple fibers can range in length from less than 0.25 mm to about 12 mm, such as from about 0.5 mm to about 7 mm, or from about 1 mm to about 3 mm. When reinforcing fiber is used, the composition may include from about 0.5 to about 20 percent by volume, such as from about 1 to about 6 percent by volume, of reinforcing fiber. In some embodiments, the reinforcing fibers are oriented within the main body portion material in a direction running perpendicular to the travel of the belt.

The composition of the main body portion material may further include a curing agent. Any curing agent capable of curing the composition of the main body portion material can be used. In some embodiments, the curing agent will be selected from a sulfur-based and/or a peroxide-based curing system. Suitable, though non-limiting, peroxide-based curing systems include dicumyl peroxide, bis-(t-butyl peroxy) diisopropyl benzene, t-butyl perbenzoate, di-t-butyl peroxide, 2,5-dimethyl-2,5-di-t-butylperoxyhexane, and α-α-bis(t-butylperoxy) diisopropylbenzene. Cure-effective amounts of peroxide curing agent may be from about 2 to about 15 phr, such as from about 4 to about 6 phr. Isocyanate curing agents can also be used. Mixtures of different types of curing system (e.g., mixed sulfur-peroxide based curing systems) can also be used.

Any other suitable additives may be included in the composition of the main body portion material. Exemplary, though non-limiting, additives that may be included are process and extender oils, antioxidants, waxes, pigments, plasticizers, softeners, anti-hydrolysis agents, and the like. In some embodiments, coagents are included in the composition of the main body material. Suitable coagents co-cure with the primary curing system (e.g., a peroxide curing system) and can help increase cure state and modulus of the composition.

As described previously, the use of millable polyurethane in the formation of the material used for the main body portion of the belt means that a solid (though pliable) sheet of main body portion material can be provided for use in the manufacturing of a power transmission belt. For example, layers or sheets of main body portion material can be prepared using millable polyurethane and other additives, and these layers or sheets can be distributed to locations where belt manufacturing takes place, such that the layers or sheets of main body portion material having milled polyurethane incorporated therein can be used in the belt manufacturing process.

The specific techniques and methods used in the formation of the main body portion material including millable polyurethane are generally not limited, provided that a pliable solid sheet or layer of main body portion material is produced. Suitable equipment includes, but is not limited to, two-roll mills, two-roll mixers, internal mixers, calendars, kneaders, etc. In some embodiments, a two-roll mill or calendar is used to create the layer of main body portion material. In such embodiments, the millable polyurethane (which in its virgin state typically has a solid but viscous consistency) is run through the two-roll mixer (or internal mixer), after which various additives to be incorporated into the material (e.g., reinforcement material, additional elastomer, curing agents, etc.) are added to the millable polyurethane running through the two-roll mill or internal mixer. Periodic end cuts can be used to help ensure that the millable polyurethane and other additives are sufficiently and evenly mixed. After sufficient milling, a pliable solid layer or sheet of main body portion material is produced. Other suitable equipment that can be used to manufacture the main body portion material includes an internal mixer, which also generally involves sequentially adding material into the mixer to produce a mass of the main body portion material. This mass may need to be passed through a mill to form sheets or layers of material. Generally speaking, the layers or sheets of material may be allowed to cool to slightly harden the material. The sheets or material are in an uncured state and contain the curing agent added during preparation of the sheets such that subsequent curing steps (e.g., during the belt manufacturing process described in greater detail below) can be carried out.

Once solid sheets of the material to be used in the formation of the main body portion of the belt are prepared, the sheets of material can be supplied to any facility where standard (i.e., non-specialized) molding equipment is available. For example, and as described in greater detail below, slab building techniques and equipment can be used to form belts when the material of the main body portion of the belt is available in the form of solid, moldable sheets. Because the equipment used for these types of belt manufacturing techniques are relatively inexpensive, the equipment is readily available and widely distributed. This means belt manufacturing can occur in multiple locations, rather than having to be limited to facilities where specialized equipment is available. This generally increases production capacity and reduces the overall cost of manufacturing such belts. Additionally, the solid sheets of main body portion material formed using millable polyurethane are more easily shipped and handled than liquid material used in other belt manufacturing processes, which reduces costs and increases production.

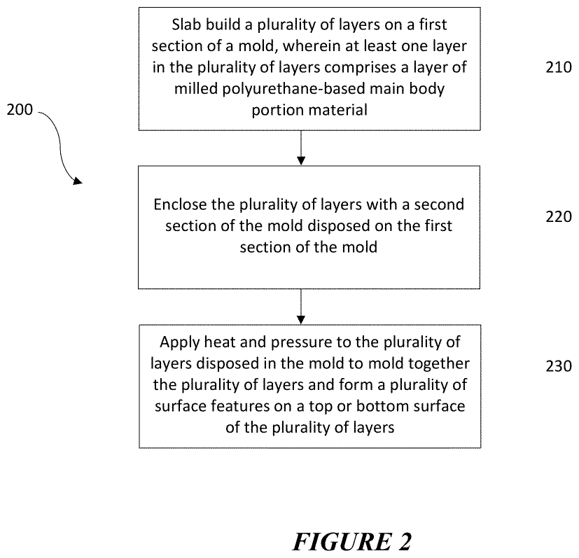

With reference to FIG. 2, a method 200 for manufacturing power transmission belts using pliable solid sheets of milled polyurethane-based material includes a step 210 of slab building a plurality of layers on a first section of a mold, wherein at least one layer in the plurality of layers comprises a layer of milled polyurethane-based main body portion material, a step 220 of enclosing the plurality of layers with a second section of the mold disposed on the first section of the mold, and a step 230 of applying heat and/or pressure to the plurality of layers disposed in the mold to mold together the plurality of layers and, in some cases, form a plurality of surface features on a top or bottom surface of the plurality of layers. The molding process is generally designed so that any surface features formed are formed in the main body portion layers (including milled polyurethane) of the belt.

With respect to step 210, slab building techniques are used to dispose a plurality of layers in a portion of a mold, the plurality of layers being the various materials of the belt sequentially disposed in the mold. That is to say, the slab building process generally entails sequentially providing each layer of the belt structure on a portion of the mold so that the mold can be enclosed and exposed to pressure and/or heat to form the structure of the belt and cure the material of the belt into its final form.

In some embodiments, the mold on which the slab build process is carried out is a cylindrical drum or mandrel, the drum having a diameter approximately equal to the diameter of the belt being formed. The specific diameter is not limited and may be any diameter desired for a belt product.

In some embodiments, a first layer to be disposed on the drum mold is a backing material. Any backing material suitable for use in belt construction can be used. Similarly, the thickness of the backing material is not limited and may be adjusted based on the desired thickness for the backing layer of the resulting belt. In some embodiments, the backing material is a rubber material, though typically a rubber material different from the elastomer material used in the main body portion of the belt. In other embodiments, the backing material may include one or more of a textile, adhesion rubber, and the like.

Following the placement of the backing material on the drum mold, the slab build process will typically call for one or more layers of the main body portion material to be wound around the backing material on the cylindrical drum. As noted previously, the layers of main body portion material are the sheets of pliable solid millable polyurethane-based material that was prepared prior to the slab build process as described in greater detail previously. For example, layers of such material can be prepared using a calendaring or milling processing at a compounding site separate from where method 200 is carried out, such that the sheets of millable polyurethane-based material can be supplied to any facility where the equipment for carrying out method 200 is located.

After a certain number of layers of the millable polyurethane-based sheet material is wound around the cylindrical mold, a cord layer can be wound around the cylindrical mold. In some embodiments, a single layer of the cord is typically wound around the mold across the entire length/width of the mold. Parameters such as the wind angle, wind tension and the spacing between adjacent winds of cord can be adjusted as desired for the finished product. Additional layers of millable polyurethane-based material is then wound around the cylinder mold such that the cords become embedded between layers of millable polyurethane-based material.

A final optional surface layer may then be applied over the millable polyurethane-based material to finish the slab build process of step 210. The surface layer may be any suitable surface layer material used in belt applications, such as knit tubes and polyethylene films. The thickness of the surface layer is generally not limited and may be adjusted based on the specific application of the belt being formed.

After the slab build process of step 210 is completed, a step 220 of applying an outer mold to encase the composite belt structure between the inner (drum cylinder) mold portion and outer mold portion is carried out. The outer portion of the mold may generally be cylindrical in a manner that mirrors the drum cylinder so as to be able to encapsulate the composite belt structure and form a belt having a uniform thickness. The outer mold may have a planar inner surface in embodiments where the belt being formed does not have teeth, ribs or the like formed therein. Alternatively, the inner surface of the outer mold may include a profile that will create whatever surface features (e.g., teeth, ribs, etc.) are desired for the belt product, including providing the generally desired dimensions, shapes and spacing for the surface features. Generally speaking, the dimensions of the profile in the outer mold is such that the outer layers of millable polyurethane-based material will be molded to thereby form surface features in this millable polyurethane-based material portion of the belt.

In step 230, which may occur at least partially simultaneously with step 220, heat and/or pressure is applied to the layers of material loaded in the mold to thereby mold together the plurality of layers, cure material in the mold, and form a plurality of surface features in the outer layers of the millable polyurethane-based material. The specific heat and pressure used in step 230 is generally not limited provided that the surface features (if provided) are molded into the millable polyurethane-based material, the composite belt structure is molded together as a whole, and any necessary curing to solidify material layers of the belt is carried out.

Once step 230 is carried out, the mold can be opened and the belt can be removed from the mold. Any necessary subsequent processing steps can be carried out, such as sectioning the larger belt into a plurality of thinner belts, grinding, polishing, etc. Based on the above-described method, the belt may also be inverted such that the surface features face radially inwardly.

While the above-described process entailed using an inner mold on which the backing layer is first disposed and an outer mold having a profile for forming surface features in the belt, it should be appreciated that the molding process and mold used can be reversed. For example, the inner mold may include the profile for forming surface features in the belt, in which case the first material disposed in the mold is the (optional) surface layer rather than the backing layer. The slab build process would then continue with disposing millable polyurethane-based material layers, cord layer, millable polyurethane-based material layers, and a backing layer, followed by enclosing the mold with an outer mold section that does not include a profile for forming surface features.

As noted previously, the specific type of power transmission belt formed in accordance with the various embodiments described herein is not limited. Exemplary belt types that can be formed using the technology described herein include, but are not limited to, synchronous belts. V-belts and micro-V belts. Similarly, the specific application in which power transmission belts formed using the technology described herein is not limited.

As used herein, the term millable polyurethane may be considered synonymous with milled polyurethane in some embodiments. For example, in embodiments where a layer of main body portion material has been prepared and/or is used in the production of a power transmission belt, the main body portion material includes a millable polyurethane that has been milled in the process of forming the layer or sheet of main body portion material, and thus the material may be considered as including milled polyurethane at that point. The key factor is that the polyurethane used in the embodiments described herein is of a type that has solid though somewhat viscous characteristics and therefore can be milled or calendared to form pliable sheets or layers of material. This is in contrast with, for example, castable polyurethanes, which cannot be milled due to their liquid nature.

From the foregoing, it will be appreciated that specific embodiments of the invention have been described herein for purposes of illustration, but that various modifications may be made without deviating from the scope of the invention. Accordingly, the invention is not limited except as by the appended claims.

Although the technology has been described in language that is specific to certain structures and materials, it is to be understood that the invention defined in the appended claims is not necessarily limited to the specific structures and materials described. Rather, the specific aspects are described as forms of implementing the claimed invention. Because many embodiments of the invention can be practiced without departing from the spirit and scope of the invention, the invention resides in the claims hereinafter appended.

Unless otherwise indicated, all number or expressions, such as those expressing dimensions, physical characteristics, etc., used in the specification (other than the claims) are understood as modified in all instances by the term “approximately”. At the very least, and not as an attempt to limit the application of the doctrine of equivalents to the claims, each numerical parameter recited in the specification or claims which is modified by the term “approximately” should at least be construed in light of the number of recited significant digits and by applying rounding techniques. Moreover, all ranges disclosed herein are to be understood to encompass and provide support for claims that recite any and all sub-ranges or any and all individual values subsumed therein. For example, a stated range of 1 to 10 should be considered to include and provide support for claims that recite any and all sub-ranges or individual values that are between and/or inclusive of the minimum value of 1 and the maximum value of 10; that is, all sub-ranges beginning with a minimum value of 1 or more and ending with a maximum value of 10 or less (e.g., 5.5 to 10, 2.34 to 3.56, and so forth) or any values from 1 to 10 (e.g., 3, 5.8, 9.9994, and so forth).

I/We claim:

1. A power transmission belt comprising a main body portion, the composition of the main body portion comprising millable polyurethane.

2. The power transmission belt of claim 1, wherein the millable polyurethane is a polyester-based millable polyurethane.

3. The power transmission belt of claim 1, wherein the millable polyurethane is a polyether-based millable polyurethane.

4. The power transmission belt of claim 1, wherein the total elastomer content of the composition of the main body portion is greater than 50 wt. % millable polyurethane.

5. The power transmission belt of claim 1, wherein the composition of the main body portion further comprises at least one additional elastomer, the one additional elastomer being different from the millable polyurethane.

6. The power transmission belt of claim 1, wherein the composition of the main body portion is a peroxide-cured composition or a sulfur-cured composition.

7. The power transmission belt of claim 1, wherein the composition of the main body portion further includes reinforcing filler, the reinforcing filler being dispersed throughout the main body portion.

8. The power transmission belt of claim 7, wherein the reinforcing filler comprises reinforcing particulate, chopped fibers, or a combination thereof.

9. The power transmission belt of claim 1, wherein a plurality of surface features are formed in a surface of the main body portion.

10. The power transmission belt of claim 9, wherein the plurality of surface features are either ribs oriented perpendicular to the rotational axis of the power transmission belt or teeth oriented parallel to the rotational axis of the power transmission belt.

11. The power transmission belt of claim 1, wherein a plurality of tensile cords are embedded in the main body portion, the plurality of tensile cords being oriented perpendicular to the rotational axis of the power transmission belt.

12. The power transmission belt of claim 1, wherein the power transmission belt is a synchronous belt, a V-belt, or a micro-V belt.

13. A method of manufacturing a power transmission belt, comprising:
slab building a plurality of layers on a first section of a mold, wherein at least one layer in the plurality of layers comprises a layer of main body portion material, the main body portion material comprising:
millable polyurethane;
enclosing the plurality of layers with a second section of the mold disposed on or over the first section of the mold; and
applying heat and/or pressure to the plurality of layers disposed in the mold to mold together the plurality of layers and optionally form a plurality of surface features on a top or bottom surface of the plurality of layers.

14. The method of claim 13, wherein the millable polyurethane is a polyester-based millable polyurethane.

15. The method of claim 13, wherein the millable polyurethane is a polyether-based millable polyurethane.

16. The method of claim 13, wherein the total elastomer content of the main body portion material is greater than 50 wt. % millable polyurethane.

17. A millable polyurethane composition suitable for use in preparing a sheet of power transmission main body portion material, the composition comprising:
a polyether- or polyester-based millable polyurethane;
optionally, at least one additional elastomer, the additional elastomer being different from the polyether- or polyester-based millable polyurethane;
a curing agent; and
a reinforcing filler dispersed through the composition.

18. The millable polyurethane composition of claim 17, wherein the total elastomer content of the composition is at least 50 wt. % millable polyurethane.

19. The millable polyurethane composition of claim 17, wherein the composition comprises the at least one additional elastomer, and the at least one additional elastomer is selected from the group consisting of: silicone rubber, EPDM, EPR, EOM, EBM, EBT, ethylene elastomers, polychloroprene, epichlorohydrin, hydrogenated nitrile butadiene rubber, natural rubber, ethylene-vinyl-acetate copolymer, ethylene methacrylate copolymers and terpolymers, styrene butadiene rubber, nitrile rubber, chlorinated polyethylene, chlorosulfonated polyethylene, alkylated chlorosulfonated polyethylene, transpolyoctenamer, polyacrylic rubbers, butadiene rubber, and mixtures thereof.

20. The millable polyurethane composition of claim 17, wherein the curing agent is a sulfur curing agent, a peroxide curing agent, or a mixed peroxide-sulfur curing agent.
